(19) United States
(12) Patent Application Publication
(10) Pub. No.: US 2007/0013249 A1
(43) Pub. Date: Jan. 18, 2007

(54) Fluid dynamic bearing system

(75) Inventors: Martin Engesser, Donaueschingen (DE); Stefan Schwamberger, Lohsa Ot. Hermsdorf (DE)

Correspondence Address: NORMAN H. ZIVIN;Cooper & Dunham LLP, 1185 Avenue of the Americas, New York, NY, 10036, US

(73) Assignee: Minebea Co., Ltd.

(21) Appl. No.: 11/484,799

(22) Filed: Jul. 11, 2006

(30) Foreign Application Priority Data
Jul. 13, 2005 (DE) 10 2005 032 630.7

(51) Int. Cl. H02K 5/16; F16C 32/06

(52) U.S. Cl. 310/90; 384/107; 384/112

(57) ABSTRACT

The invention relates to a fluid dynamic bearing system. It comprises a stationary part consisting of a cup-shaped housing and a bearing bush disposed therein, and a moving part consisting of an arrangement of a shaft and a hub rotatably accommodated in the bearing bush. The respective surfaces opposing each other of the stationary part and the moving part are spaced apart from each other by a bearing gap filled with bearing fluid. At least one radial bearing is provided that is formed by the outer surface of the shaft and the inner surface of the bearing bush and associated hydrodynamic bearing patterns. An axial bearing is formed by an end face of the bearing bush, an opposing end face of the hub and associated hydrodynamic bearing patterns. The shaft is held by a flange disposed at one of its ends that is accommodated in an annular disk-shaped space formed by the housing and the bearing bush.

### BACKGROUND OF THE INVENTION

The invention relates to a fluid dynamic bearing system used preferably to rotatably support a small-scale spindle motor, as preferably employed for driving hard disk drives.

### PRIOR ART

The ongoing miniaturization of hard disk drives is giving rise to new problems in their design and construction, particularly with regard to the design and construction of small drive motors and suitable bearing systems. Although roller bearing systems have mainly been used to date, fluid dynamic bearing systems are becoming increasingly popular due to their small-scale construction and greater precision.

It is known to provide existing bearing systems with two radial bearings. In order to achieve the required bearing stiffness, the radial bearings have to be disposed at a sufficient axial distance from one another. However, conventional solutions in the design of fluid dynamic hard disk drive bearings and methods for their manufacture are either impossible to apply or can only be applied with difficulty in the design and construction of miniature spindle motors. The smaller the bearing systems become, and thus the distance between the two radial bearings, the lower are their load-bearing capacity and stiffness when conventional construction methods are used. Conventional small-scale bearing bushes are mainly made from steel. These steel bushes are mostly provided with bearing patterns using an ECM process and are thus relatively expensive to produce.

DE 102 31 962 A1 reveals a conventionally designed hydrodynamic bearing system for the rotational support of a spindle motor that comprises two radial bearings disposed at a spacing to each other, and adjoining axial bearings. The axial bearings are located opposite the free end of the shaft that carries the hub of the spindle motor. This means that the tilt resistance of this bearing system is determined primarily by the radial bearings, particularly the distance between them. This inevitably results in a relatively large overall height for the bearing system as well as for the spindle motor in which it is mounted.

### SUMMARY OF THE INVENTION

It is thus the object of the invention to create a fluid dynamic bearing for the rotational support of a spindle motor that, in the case of a small-scale construction and particularly of a low overall height, has high bearing stiffness and is relatively inexpensive to produce.

This object has been achieved according to the invention by the characteristics outlined in claim 1.

Preferred embodiments and other beneficial characteristics of the invention are cited in the subordinate claims.

The fluid dynamic bearing system according to the invention comprises a stationary part consisting of a cup-shaped housing and a bearing bush disposed within the housing, and a moving part consisting of an arrangement of a shaft and a hub that is rotatably accommodated in the bearing bush. The surfaces opposing each other of the stationary and moving part are spaced apart from each other by a bearing gap filled with bearing fluid. At least one radial bearing is provided that is formed by the outer surface of the shaft and the inner surface of the bearing bush as well as the associated hydrodynamic bearing patterns. An axial bearing is formed by the end face of the bearing bush, an opposing end face of the hub and associated hydrodynamic bearing patterns. The shaft is held by a flange disposed at one of its ends that is accommodated in an annular disk-shaped space formed by the housing and the bearing bush.

Integrating the functions of the components means that the bearing system according to the invention is made up of only a few components. These components can be made using conventional manufacturing processes. The required tilt resistance is provided by the axial bearing disposed close to the plane of the center of gravity of the hub. This makes it possible to keep the overall height low making for high axial stiffness. The required radial stiffness is provided by the radial bearing.

In a first embodiment of the invention the bearing patterns of the radial bearing are disposed on the outside circumference of the shaft and the bearing patterns of the axial bearing on the end face of the bearing bush.

In a preferred embodiment of the invention, all the bearing patterns, i.e. the bearing patterns of the radial bearing and those of the axial bearing, are disposed solely on the bearing bush. This makes manufacturing much less expensive since, with regard to the bearing patterns, only the bearing bush need be machined, thus simplifying the manufacture of the bearing and making it more cost-effective.

It is advantageous if the bearing bush is made as a sintered part, using either sintered metal or sintered ceramics. Plastics/metal sintered materials could also be used. The advantages provided by sintering include cost-effective manufacture as well as the possibility of integrating the bearing patterns at an early stage into the sintered part. This eliminates the need for any finishing work and the later application of bearing patterns to the surfaces of the bearing bush.

The bearing bush is held in the housing, the bearing bush having an increased diameter in its upper region, i.e. on the side facing the hub, the increased diameter exceeding the largest diameter of the housing. The hub is cup-shaped and accommodates the bearing sleeve and the housing to a large extent. An annular space, connected to the bearing gap and tapered in the direction of the bearing gap, is disposed in the region of the open end of the bearing gap between a surface of the inside circumference of the hub and an opposing surface of the outside circumference of the housing, the annular space being at least partly filled with bearing fluid. This space defines the bearing gap towards the outside and, in a first function, forms a capillary seal to seal the bearing gap and in a second function, it forms a reservoir for the bearing fluid.

In a preferred embodiment, the housing takes the form of a one-piece, cup-shaped part, such as a deep-drawn part. However, the housing can also be designed as a turned part.

The bearing system according to the invention is preferably employed to rotatably support a spindle motor, the spindle motor having a baseplate or a flange having an opening to receive the housing of the bearing system, and an electromagnetic drive unit to drive the moving part of the bearing system.

The spindle motor can preferably be used for driving the storage disks of a hard disk drive, the hub being used as a carrier for the at least one storage disk of the hard disk drive.

The invention is explained in more detail below on the basis of an embodiment with reference to the drawings. Further characteristics, advantages and possible applications of the invention can be derived from the drawings and their description.

### BRIEF DESCRIPTION OF THE DRAWINGS

The drawings show:

FIG. 1: a section through a spindle motor having a fluid dynamic bearing system according to the invention;

FIG. 2: a top view of the bearing sleeve of the bearing system;

FIG. 3: a section through the bearing sleeve of FIG. 2;

FIG. 4: a bottom view of the bearing sleeve of FIG. 2;

FIG. 5: a section through a spindle motor having a slightly modified embodiment of the bearing system according to the invention over the embodiment in FIG. 1.

### DESCRIPTION OF PREFERRED EMBODIMENTS OF THE INVENTION

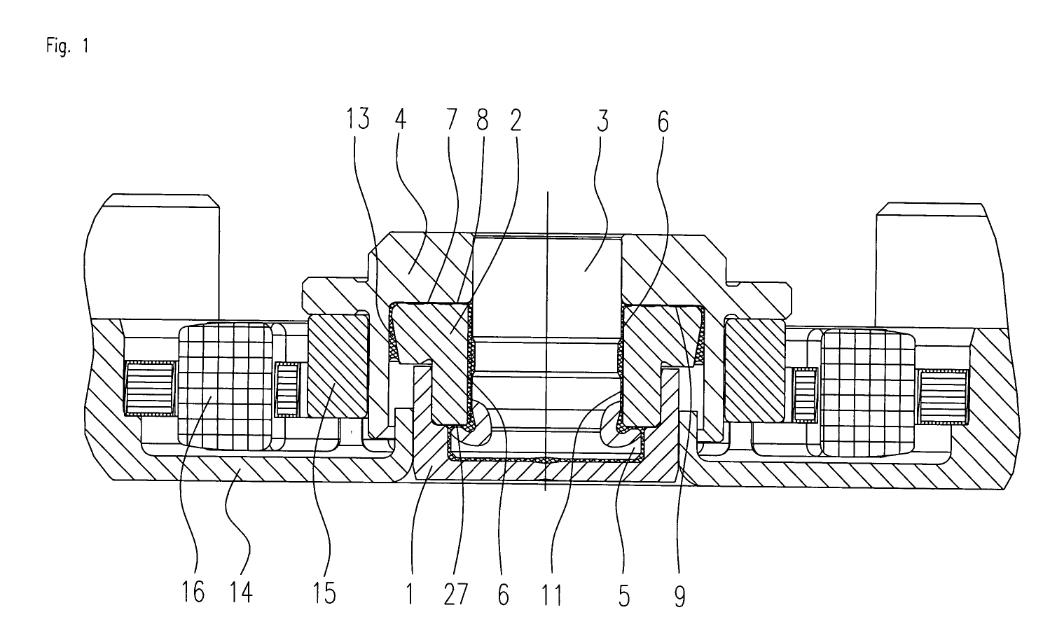

FIG. 1 shows the basic construction of a spindle motor having a first embodiment of the fluid dynamic bearing system according to the invention. The spindle motor 1 is characterized by its simple design and flat construction.

The spindle motor comprises a baseplate 14 or a base flange that is designed, for example, as a deep-drawn part and has an opening in which a substantially cup-shaped housing 1 is inserted, the cup-shaped housing possibly being designed as a turned part. A bearing bush 2 is disposed in the region of the opening in the housing 1 at its inside diameter, the bearing bush together with the housing 1 forming the stationary part of the bearing system. The bearing bush 2 comprises a cylindrical section, which is pressfitted, for example, into the housing 1, and an upper toric section that protrudes both axially and radially beyond the dimensions of the housing. A shaft 3 which carries a hub 4 of the spindle motor is rotatably accommodated in a concentric bore in the bearing bush 2. The hub 4 is fixed to the end of the shaft, pressed to it, for example, or welded. The length of the shaft 3 is longer than that of the bearing bush 2 so that one end of the shaft protrudes from the bearing bush 2 and forms a flange 5 that abuts the lower end face of the bearing sleeve 2. The flange 5 is disposed in an annular disk-shaped cavity within the housing formed by the housing 1, the shaft 3 and the bearing bush 2.

This flange 5 acts as an axial safeguard for the shaft 3, preventing it from falling out of the bearing sleeve 2. The shaft 3 with the flange 5 and the hub 4 together form the moving part of the bearing system.

The respective opposing surfaces of the bearing bush 2 and the shaft 3 or of the housing 1, the flange 5 and the bearing bush 2 respectively are spaced apart from one another by a bearing gap 6 filled with a bearing fluid, such as a bearing oil. The bearing gap has a width, for example, of 2 to 20 micrometers.

The hydrodynamic bearing system comprises a radial bearing 11 that is formed by the outer surface of the shaft 3 and the opposing inner surface of the bearing bush 2 as well as the associated hydrodynamic bearing patterns 12 that can be disposed on the surface of the shaft 3 and/or the inner surface of the bearing bush 2.

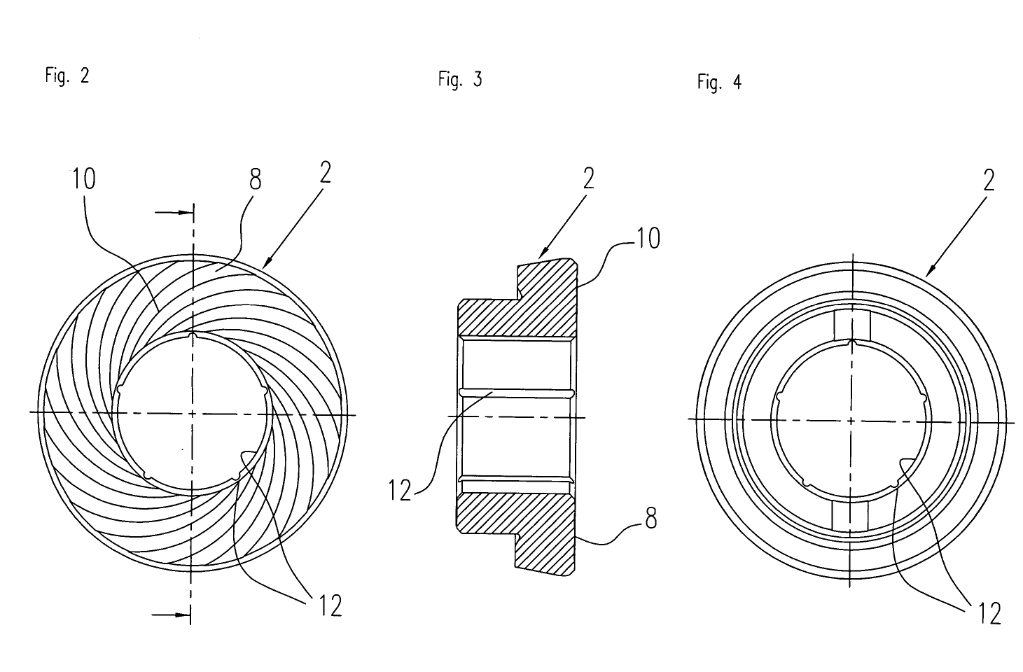

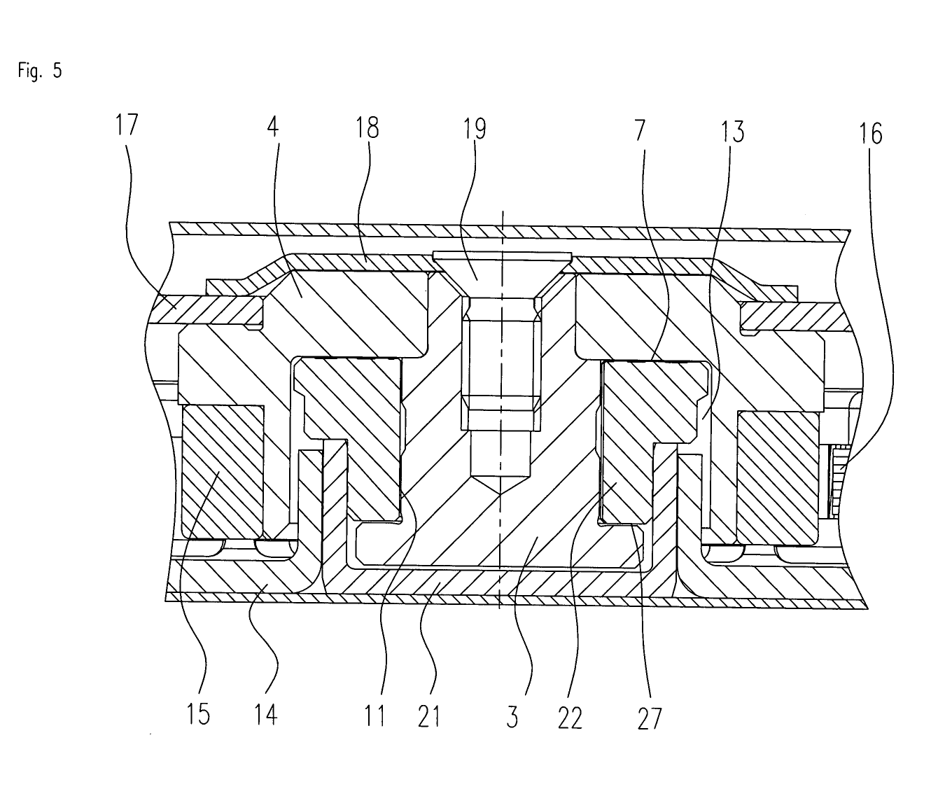

In FIGS. 2 to 4, for example, it is possible to see the radial bearing patterns 12 that are provided on the inner surface of the bearing bush 2.

The bearing system further comprises an axial bearing 7 that is formed by an end face 8 of the bearing bush 2, an opposing end face 9 of the hub 4 as well as associated hydrodynamic bearing patterns 10 that are preferably disposed on the end face 8 of the bearing bush 2 as shown, for example, in FIG. 2.

The bearing patterns can of course also be disposed on the end face 9 of the hub 4, although this is less desirable for manufacturing reasons.

Another axial bearing 27 can further be formed between the underside of the bearing bush 2 and the opposing topside of the flange 5. The hydrodynamic bearing patterns can be disposed on the underside of the bearing bush 2 and/or on the topside of the flange.

FIGS. 2 to 4 show different views of the bearing bush 2 giving a clear illustration of the radial and the axial bearing patterns 12, 10 on the respective surfaces of the bearing bush 2. It is preferable if all the bearing patterns, i.e. those of the radial and of the axial bearing 11 or 7, 27 are disposed solely on the bearing bush 2. This means that only the bearing bush 2 need be machined accordingly, where the bearing bush can be manufactured advantageously as a sintered part in which the bearing patterns can be integrated at an early stage into the blank.

FIGS. 2 to 5 show that the bearing patterns 12 of the radial bearing 11 provided on the inside diameter of the bearing bush 2 are formed, for example, by five asymmetric, circular arc-shaped sections that are each interrupted by five axial channels. On rotation of the bearing system, this design of the inner surface of the bearing bush exerts pressure on the bearing fluid giving the radial bearing its load-carrying capacity. When conventional machining processes such as drilling and milling are used, it is very expensive to produce this kind of radial bearing pattern 12. Manufacturing the bearing bush 2 as a complete sintered part, however, makes it very simple to realize these kinds of bearing patterns 12 thus making them a useful option.

The bearing patterns 10 of the axial bearing on the end face 8 of the bearing bush 2 are given a herringbone shape, for example, and again generate a pressure-generating pumping action on the bearing fluid giving the bearing system its load-carrying capacity.

The bearing gap 6 ends in the region of the first axial bearing 7 and is defined by a space 13 that is formed between the inside circumference of the hub 4 and the toric outside circumference of the bearing bush 2. Whereas the inside diameter of the hub 4 remains the same in this region, the outside diameter of the bearing bush 2 continues to increase in the region of the bulge so that the annular space 13 tapers, narrowing in the direction of the bearing gap 6 or of the axial bearing and merges into the bearing gap 6. The space 13 acts on the one hand as a capillary seal for the bearing gap 6 and on the other hand as a supply volume, i.e. a reservoir, for the bearing fluid. The space 13 is consequently also partly filled with bearing fluid.

The electromagnetic drive system of the spindle motor containing the bearing system is disposed outside the bearing system at the outside circumference of the hub 4 or about the hub 4. The drive system comprises permanent magnets 15 that are disposed at the outside circumference of the hub 4 as well as a stator arrangement 16 that is disposed opposite the magnets 15 and generates an alternating electromagnetic field which sets the hub 4 and thus the rotating part of the spindle motor in rotation.

FIG. 5 shows a partial section of a spindle motor having a slightly modified embodiment of the bearing system according to the invention than that of FIG. 1. In FIG. 5 identical components to those in FIG. 1 are given the same reference numbers. For a description of these components, reference is made to the description of the drawings of FIG. 1.

In contrast to FIG. 1, the housing 21 that receives the bearing system is designed as a simple, cylindrical, deep-drawn part closed at one end. The bearing bush 22 held in the housing 21 again has a toric bulge that protrudes beyond the housing 21 whose diameter, however, does not change regularly but rather in steps so that the annular space 13 also tapers in steps and merges into the bearing gap 6.

It is also shown that a storage disk 17 of a hard disk drive is mounted on the hub 4 of the spindle motor, more precisely on an upper shoulder of the hub, the storage disk then being accordingly driven in rotation by the spindle motor. The storage disk 17 is held onto the hub 4 by a disk-shaped clamp 18 that is fixed in a bore in the shaft 3 by means of a screw.

### IDENTIFICATION REFERENCE LIST

1 Housing

2 Bearing bush

3 Shaft

4 Hub

5 Flange

6 Bearing gap

7 Axial bearing

8 End face (bush)

9 End face (hub)

10 Bearing patterns

11 Radial bearing

12 Bearing patterns

13 Space (reservoir)

14 Baseplate

15 Magnet

16 Stator arrangement

17 Storage disk

18 Clamp

19 Screw

20 Housing

21 Housing

22 Bearing bush

27 Axial bearing

1. A fluid dynamic bearing system comprising: a stationary part consisting of a cup-shaped housing (1) and a bearing bush (2) disposed therein, a moving part consisting of an arrangement of a shaft (3) and a hub (4) rotatably accommodated in the bearing bush (2), the respective surfaces opposing each other of the stationary part and the moving part being spaced apart from each other by a bearing gap (6) filled with bearing fluid; a radial bearing (11) formed by the outer surface of the shaft (3) and the inner surface of the bearing bush (2) and associated hydrodynamic bearing patterns (12); an axial bearing (7) formed by an end face (8) of the bearing bush (2), an opposing end face (9) of the hub (4) and associated hydrodynamic bearing patterns (10), and a flange (5) disposed at one end of the shaft (3) that is accommodated in an annular disk-shaped space formed by the housing and the bearing bush.

2. A bearing system according to claim 1, characterized in that an additional axial bearing (27) is formed between the underside of the bearing bush (2) and the topside of the flange (5).

3. A bearing system according to claim 1, characterized in that the bearing patterns (12) of the radial bearing are disposed on the outside circumference of the shaft (3) and the bearing patterns (10) of the axial bearing on the end face (8) of the bearing bush (2).

4. A bearing system according to claim 1, characterized in that the bearing patterns (12, 10) of the radial and of the axial bearing are disposed solely on the bearing bush (2).

5. A bearing system according to claim 1, characterized in that the bearing bush (2) is a sintered part.

6. A bearing system according to claim 1, characterized in that the bearing bush (2) has an increased diameter on its side facing the hub (4), the increased diameter exceeding the largest diameter of the housing (1).

7. A bearing system according to claim 1, characterized in that an annular space (13), connected to the bearing gap (6) and tapered in the direction of the bearing gap, is disposed between a surface of the inside circumference of the hub (4) and an opposing surface of the increased diameter of the bearing bush (2), the annular space being at least partly filled with bearing fluid.

8. A bearing system according to claim 7, characterized in that the space (13) defines the bearing gap (6) towards the outside and forms a capillary seal to seal the bearing gap.

9. A bearing system according to claim 7, characterized in that the space (13) forms a reservoir for the bearing fluid.

10. A spindle motor having a bearing system according to claim 1, further comprising, a baseplate (14) having an opening to receive the housing (1) of the bearing system, and an electromagnetic drive unit (15, 16) for driving the moving part of the bearing system.

11. A spindle motor according to claim 10, characterized in that it forms a part of a hard disk drive.

12. A spindle motor according to claim 10, characterized in that the hub (4) is designed as a carrier for a storage disk (17) of the hard disk drive.
